(19) United States
(12) Patent Application Publication
(10) Pub. No.: US 2007/0176482 A1
(43) Pub. Date: Aug. 2, 2007

(54) Customized bicycle wheel assembly and method

(76) Inventor: Harry Culiver III, Dallas, TX (US)

Correspondence Address: GRADY K. BERGEN, 3333 LEE PARKWAY, SUITE 600, DALLAS, TX, 75219, US

(21) Appl. No.: 11/332,988

(22) Filed: Jan. 17, 2006

(51) Int. Cl. B60B 27/00

(52) U.S. Cl. 301/110.5

(57) ABSTRACT

A bicycle wheel assembly is disclosed that includes a wheel and a pair of decorative wheel mounts. The wheel includes a hub for mounting to the frame of a bicycle, a rim disposed radially outward from the hub and which is configured for receiving a tire, and a support structure extending radially between the hub and the rim. The wheel mounts are mounted axially outward from either side of the radial support structure of the wheel. Each wheel mount overlays the radial support structure of one side of the wheel to provide a decorative appearance on each side. The wheel mounts may be rotatably or non-rotatably mounted to the wheel to allow rotation or non-rotation of the wheel mount relative to the wheel.

### BACKGROUND

The invention relates to bicycles, and more particularly to wheels for bicycles.

### BRIEF DESCRIPTION OF THE DRAWINGS

For a more complete understanding of the present invention, reference is now made to the following descriptions taken in conjunction with the accompanying figures, in which:

FIG. 1 is a side elevational view of a bicycle employing wheel assemblies constructed in accordance with the invention;

FIG. 2 is a perspective view of a wheel assembly, shown with wheel mounts exploded away from a wheel of the wheel assembly;

FIG. 3A is a cross-sectional view a hub of the wheel assembly of FIG. 2, shown with the wheel mount rotatably mounted to the wheel to allow independent rotation of the wheel mount relative to the wheel;

FIG. 3B is a cross-sectional view a hub of the wheel assembly of FIG. 2, shown with the wheel mount non-rotatably mounted to the wheel; and

FIG. 4 is a side elevational view of a wheel assembly having a wheel mount that includes illumination members in accordance with an embodiment of the invention.

### DETAILED DESCRIPTION

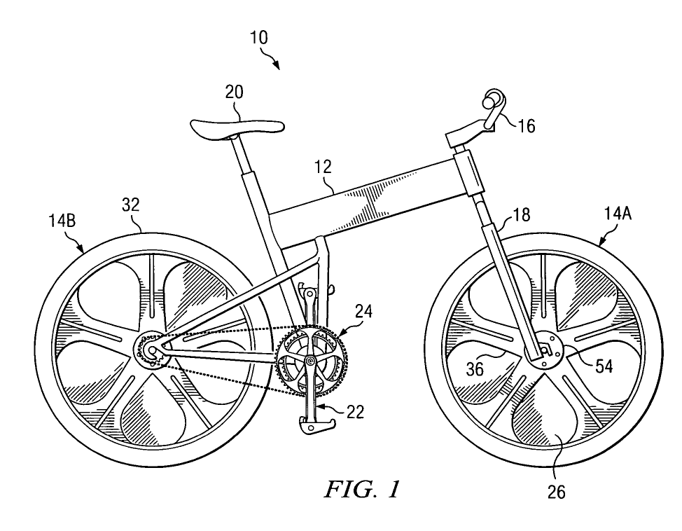

Referring to FIG. 1, a bicycle 10 having a frame 12 that is mounted to and carried by front and rear wheel assemblies 14A, 14B is shown. Handle bars 16 for steering the bicycle 10 are provided that rotate a front fork 18 of the frame 12, which is carried by the front wheel assembly. A seat 20 is mounted to the frame for seating a rider. A crank and pedal assembly 22 of the bicycle 10 is coupled to a gear and chain assembly 24 for driving the rear wheel assembly 14A. A braking system (not shown) as well as other components that may be employed with bicycles may also be included with the bicycle 10. Although the bicycle 10 is shown in one configuration, other configurations could be used as well without departing from the invention.

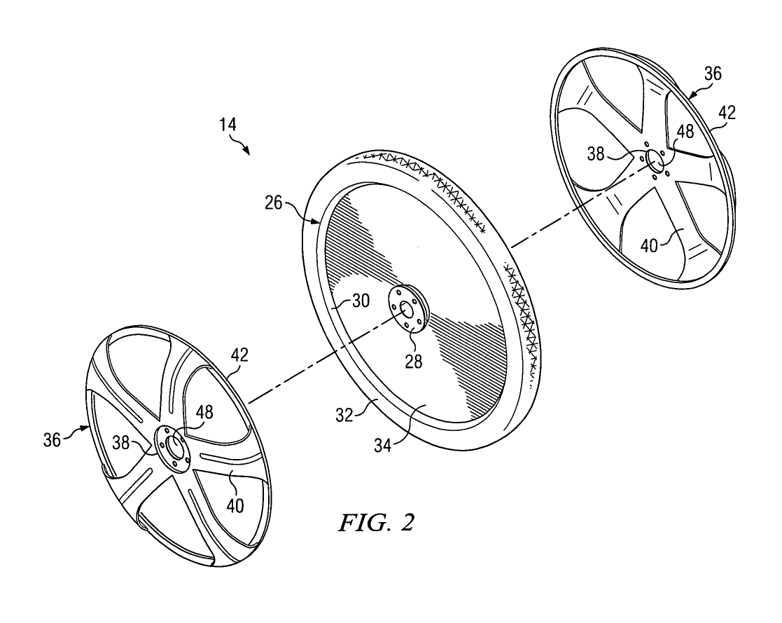

FIG. 2 shows the wheel assembly 14, which is intended to generally represent both the front and rear wheel assemblies 14A, 14B. It should be apparent to those skilled in the art that the front and rear wheel assemblies may have certain differences, such as the rear wheel assembly 14A carrying sprockets or gears for driving the rear wheel. The wheel assembly 14 includes a wheel 26 having a central hub 28 for rotatably mounting the wheel 26 to the frame 12 of the bicycle 10. The wheel 26 further includes a circumferential rim 30 disposed radially outward from the hub 28. The rim 30 is configured for receiving a tire 32 of the bicycle 10.

A support structure 34 extends radially between the hub 28 and rim 30. The support structure 20 may be a generally circumferentially continuous or non-continuous, spokeless structure that extends circumferentially about the hub 28, and extends radially outward to the rim 30. The support structure 34 may be recessed from the outer edge of the rim 30. The support structures may also have various shaped holes, apertures or open areas so that portions of the support structure 34 are circumferentially non-continuous and allow visual perception through the support structure through such areas. The support structure 34 may have various configurations and have recesses, projections or other non-uniform surface features. The support structure 34 may have an overall generally flat, convex or concave outer surface. The support structure 34 may also provide a continuous outer surface over its entire extent so that visual perception through the entire support structure 34 is prevented. The support structure 34 may also include a mesh or lattice structure so that visual perception through the openings of the mesh or lattice structure is allowed. The support structure 34 may be in the form of circumferentially spaced apart spokes (not shown) extending radially from the hub 28 to the rim 30.

The wheel 26 may have different diameters. This may include wheel sizes that range from about 12 inches or less to about 30 inches or more. Typical wheel sizes for bicycles include 12, 16, 18, 20, 22, 24, 26, 27, 28 and 29 inches. The rim 30 may have a width of 3 inches or less, more typically 2 inches or less.

A pair of wheel mounts 36 are provided with the wheel assembly 14. The wheel mounts 36 are mounted to the wheel 26 axially outward from either side of the support structure 34 and generally overlay the support structure 34. In the embodiment shown, the wheel mount 36 has a hub or central portion 38. Spokes or radial structure 40 of the wheel mount 36 extends radially outward from the central portion 38 and may terminate at an outer circumferential rim 42 of the wheel mount 36. In certain embodiments, the circumferential rim 42 may be eliminated.

The radial extending structure 40 may have various shaped holes, apertures or open areas so that portions of the structure 40 are circumferentially non-continuous and allow visual perception through the structure 40 through such areas. The structure 40 may have various configurations and have recesses, projections or other non-uniform surface features. The structure 40 may have an overall generally flat, convex or concave outer surface. The structure 40 may also have an undulating configuration wherein the structure 40 bows outwards or inwards from the hub 38 and rim 42, with the hub 38 and rim 42 being generally co-planar or non-coplanar. In the embodiment shown in FIG. 2, the wheel mount 36 has a concave configuration so that the structure 40 projects axially outward from an outer rim 42 to the hub 38. The wheel mounts 36 may be configured to approximate or generally replicate wheels that are similar to the styles used in automotive and motorcycle wheels.

The wheel mount 36, as well as the wheel 26, may be formed of the same or different materials. Suitable materials include various metals or metal alloys. These may include aluminum, iron, titanium, magnesium, as well as other metals and alloys known to those skilled in the art that may provide the necessary structural support and integrity for use in a bicycle wheel and for the purposes described herein. Non-metal materials include various plastics or polymeric materials and composite materials, such as fiberglass, carbon fiber, graphite, boron fiber, etc. Other non-metal materials could be used, as well, such as are known to those skilled in the art or may come into existence. In particular, cast aluminum and molded carbon fiber wheels and wheel mounts may be employed in the present invention. 380 aluminum is particularly well suited for construction of the wheel and wheel mounts. The wheel mount and wheel may be individually cast as a single unitary piece or in multiple components that are assembled together. Squeeze or die casting may be used in forming the wheels and wheel mounts. Examples of methods of forming metal and non-metal wheels are presented in U.S. Pat. No. 4,035,895, which is herein incorporated by reference. The wheel or wheel mounts may be of solid or hollow construction. U.S. Pat. No. 4,930,843, which is herein incorporated by reference, discloses a hollow construction for a bicycle wheel which may be similarly employed in the construction of the wheel or wheel mounts of the present invention.

The surfaces of the wheel and wheel mounts may be treated to provide a desired appearance. In particular, the surfaces may be provided with a surface finish. These may include a plated chrome finish or a painted chrome finish, such as Mirra Chrome™ painted coatings. The surface treatment may provide a shiny or matte finish. In some embodiments, the wheel and wheel mount may have different surface finishes. In particular, a dark surface finish, which may be shiny or matte, may be provided on the wheel or portions of the wheel 26. The wheel mount 36 may be provided with a lighter or contrasting surface finish to contrast with those portions of the wheel that are visible through open areas of the wheel mount. The surfaces may also be provided with variations in color or texture and may include different colors, designs, emblems or indicia.

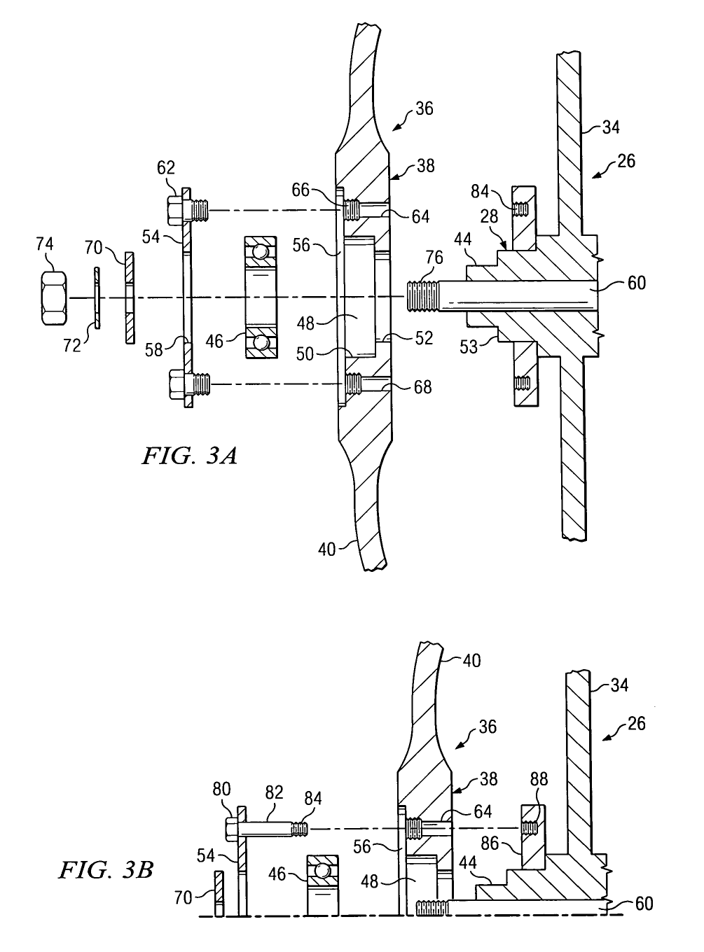

FIG. 3A shows the wheel mount 36 mounted to the wheel 26 in a spinning or rotatable mode so that the wheel mount 36 acts as a spinner. Although the description that follows provides one possible means of rotatably mounting the wheel mount 36 to the wheel 26, other means for rotatably mounting of the wheel mount may be used as well. The wheel mount 36 is rotatably mounted to a sleeve 44 of the hub 28 of the wheel 26 through a ball bearing assembly 46. The bearing assembly 46 may be a sealed bearing assembly to prevent entry of debris, dust, dirt other matter into the bearing. The central portion or hub 38 of the wheel mount 36 is provided with a central opening 48, which defines a bearing recess 50. A retaining lip 52 engages the outer race of the bearing 46 and prevents passage of the bearing 46 through the rear of the opening 48, as is shown. When the wheel mount 36 is rotatably mounted to the wheel 26, the inner race of the bearing assembly seats over sleeve 44, with a radially outward projecting lip 53 of hub 28 abutting against the inner race of the bearing 46.

A cover plate 54 is provided with the wheel mount 36. The cover plate 54 may be received within a shallow recess or hollowed area 56 formed in the outer portion of the wheel mount 36, which may be concentric with the central opening 48. The cover plate 54 is provided with a central opening 58 to allow passage of a hub bolt 60 of the wheel hub 28 therethrough. The cover plate 54 is bolted to the wheel mount 36 through threaded bolts 62 that are received within apertures or bolt holes 64 formed in the wheel mount 36. As can be seen in FIG. 3A, the apertures 64 are provided with a first forward threaded portion 66 and a smooth bored rearward portion 68. The threaded bolts 62 are sized to engage the threaded portion 66.

The radially innermost portion of the cover plate 54 is configured to engage the outer race of the bearing 46 to retain the bearing 46 within the recess 48. A bearing retaining member or ring 70 having central opening for passage over hub bolt 60 is sized to engage the inner race of the bearing assembly 46. The wheel mount 36 is retained on the hub 28 through washer 72, which abuts against bearing retaining member 70, and nut 74, which engages threaded end portion 76 of hub bolt 60.

When the wheel mount 46 is mounted to the wheel 26 in a rotatable manner as shown in FIG. 3A, the wheel mount 46 acts as a spinner that is free to rotate relative to the wheel 26. The wheel mount 46 may be configured so that it catches air as the bicycle is ridden to thus facilitate spinning of the wheel mount 46. Additionally, inertia and slight frictional forces imparted by the wheel 26 may cause the wheel mount 46 to rotate as the bicycle is ridden.

It should be noted that although the wheel mount 46 is rotatably mounted to the hub 26, the wheel mount may also be rotatably mounted through the rim 30. U.S. Pat. No. 6,554,370, which is herein incorporated by reference in its entirety for all purposes, illustrates how a wheel mount may be rotatably mounted through an outer rim of a wheel.

The total weight of the wheel and wheel mounts may be less than 10 pounds, with from 4 to 6 pounds being typical. The wheel mounts may have an individual weight of 3 pounds or less. The wheel and wheel mounts may be formed to provide the lightest weight possible while still providing sufficient structural integrity and strength to serve their intended purposes.

Referring to FIG. 3B, the wheel mount 36 is shown mounted to the wheel 26 in a non-rotatable mode. In this mode, the bolts 62 are replaced with bolts 80. The bolts 80 are longer and may have shanks that are smaller in diameter than those of the bolts 62 to facilitate passage of the bolt 80 through the apertures 64. The bolts 80 may be provided with a smooth shank 82 and a threaded end portion 84.

A mounting plate 86 is provided on the hub 28 of the wheel 26. The mounting plate 86 is rigidly coupled or formed with the hub portion 28 so that it rotates with the wheel 26. Threaded apertures 88 are provided in the mounting plate 86 and are configured to align with at least some of the apertures 64 of the wheel mount 36. Alternatively, separate bolt holes or apertures may be formed in the wheel mount 46 to specifically accommodate the bolts 80. The bolts 80 thread into the threaded apertures 64 so that the wheel mount 36 is rigidly or non-rotatably mounted to the wheel 26.

In use, the bicycle wheel assemblies 14 are mounted to the bicycle frame 12. The wheel mounts 36 may be rotatably or non-rotatably mounted to the wheels 26 by use of the different bolting members 62, 80. Other means of non-rotatably mounting the wheel mount 46 to the wheel 26 may be used as well, such as replacing the bearing assembly 46 with a non-rotating insert.

The wheel mounts 36 provide a custom appearance that is not provided in conventional bicycle wheels. The wheel assemblies 14 provide a unique appearance that simulates or replicates the appearance of custom automotive or motorcycle wheels. When the wheel mounts 36 are rotatably mounted to the wheels 26, they act as spinners, which also provide a unique appearance that is similar or replicates those spinners used in custom automotive wheels. The wheel mounts 36 can optionally be mounted so that they are non-rotatable relative to the wheel. Two or more pairs of wheel mounts 36 may be provided with each wheel so that a different appearance can be provided with the same wheel by interchanging wheel mounts. Optionally, the wheel mounts may be removed entirely so that the wheel functions without the wheel mounts.

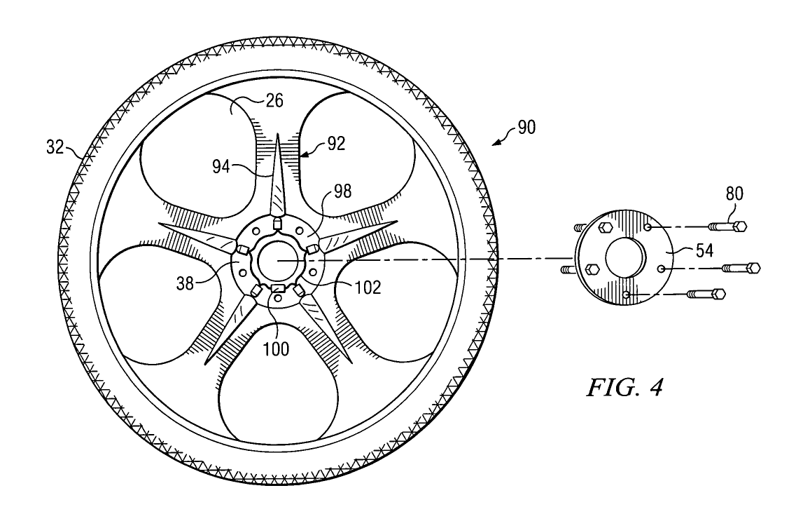

Referring now to FIG. 4, still another embodiment of a wheel assembly 90 is shown. The wheel assembly 90 is similar to the wheel assembly 14, previously described, with similar elements indicated with the same reference numeral. The wheel assembly 90 includes a wheel mount 92 that includes illumination members 94. The illumination members may be translucent members of various configurations, which may be the same or different, that are incorporated with the structure 40 and may extend from the hub 38. The members 94 may constitute electric lights having an illuminating source for lighting the member 94. In the embodiment shown, separate LED lights 96 are supplied that are housed within recess or hollowed area 98 of the hub 38 and in light communication with the members 94. An electrical power source 100 in the form of a battery is electrically coupled to the lights 96, such as through wiring 102. The cover plate 54 is used to close off the hollow area 98 to access the lights 96 and power source 100. The members 84 or illuminating source 96 may be the same or of different colors. The lights may be continuously illuminating, blink, flash or otherwise be intermittent and/or vary in intensity. This provides a very unique appearance to the bicycle wheel. A motion sensor or other controller (not shown) may also be provided to vary the intensity or regulate the illumination based upon the rotation rate of the wheel or wheel mount or operation of the bicycle 10.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

I claim:

1. A bicycle wheel assembly comprising:
a wheel including:
a hub for mounting to the frame of a bicycle;
a rim disposed radially outward from the hub and being configured for receiving a tire;
a support structure extending radially between the hub and the rim; and
a pair of decorative wheel mounts mounted axially outward from either side of the radial support structure of the wheel, each wheel mount overlaying the radial support structure of one side of the wheel to provide a decorative appearance on each side.

2. The assembly of claim 1, wherein;
each wheel mount is rotatably mounted to the wheel to allow independent rotation of the wheel mount relative to the wheel.

3. The assembly of claim 1, wherein:
each wheel mount is selectively rotatably or non-rotatably mounted to the wheel to selectively allow rotation or non-rotation of the wheel mount relative to the wheel.

4. The assembly of claim 1, wherein:
portions of the support structure are circumferentially non-continuous.

5. The assembly of claim 1, wherein:
the support structure is circumferentially continuous.

6. The assembly of claim 1, wherein:
the wheel mount includes an illumination member with an electrically powered illuminating source for illuminating the illumination member.

7. The assembly of claim 1, wherein:
the wheel mount generally radially and circumferentially coextends with the radial support structure of the wheel.

8. The assembly of claim 1, wherein:
the wheel mount and the radial support structure each have a different surface finish to provide a contrasting appearance.

9. A bicycle wheel assembly comprising:
a wheel including:
a hub for mounting to the frame of a bicycle;
a rim disposed radially outward from the hub and being configured for receiving a tire;
a support structure extending radially between the hub and the rim; and
a pair of decorative wheel mounts mounted axially outward from either side of the support structure of the wheel, each wheel mount overlaying the support structure of one side of the wheel to provide a decorative appearance on each side, each wheel mount being rotatably mounted to the wheel to allow independent rotation of the wheel mount relative to the wheel, the wheel mount generally radially and circumferentially coextending with the radial support structure of the wheel.

10. The assembly of claim 9, wherein:
each wheel mount is selectively rotatably or non-rotatably mounted to the wheel to selectively allow rotation or non-rotation of the wheel mount relative to the wheel.

11. The assembly of claim 9, wherein:
portions of the support structure is circumferentially non-continuous.

12. The assembly of claim 9, wherein:
the support structure is circumferentially continuous.

13. The assembly of claim 9, wherein:
the wheel mount includes an illumination member with an electrically powered illuminating source for illuminating the illumination member.

14. The assembly of claim 9, wherein:
the wheel mount generally radially and circumferentially coextends with the radial support structure of the wheel.

15. The assembly of claim 9, wherein:
the wheel mount and the radial support structure each have a different surface finish to provide a contrasting appearance.

16. The assembly of claim 9, wherein:
each wheel mount has a weight of about 3 lbs or less.

17. The assembly of claim 9, wherein:
the wheel mount has a convex configuration.

18. A method of providing a decorative appearance to a bicycle wheel assembly comprising:
providing a wheel including:
a hub for mounting to the frame of a bicycle;
a rim disposed radially outward from the hub and being configured for receiving a tire;
a support structure extending radially between the hub and the rim; and
providing at least one pair of decorative wheel mounts mounted axially outward from either side of the radial support structure of the wheel, each wheel mount overlaying the radial support structure of one side of the wheel to provide a decorative appearance on each side.

19. The method of claim 18, wherein:
at least two pair of decorative wheel mounts are provided that may be interchanged to provide a different decorative appearance to the wheel.

20. The method of claim 18, wherein:
each wheel mount is rotatably mounted to the wheel to allow independent rotation of the wheel mount relative to the wheel.
